(19) United States
(12) Patent Application Publication
(10) Pub. No.: US 2022/0267198 A1
(43) Pub. Date: Aug. 25, 2022

(54) THIN FLEXIBLE GLASS COVER WITH A FRAGMENT RETENTION HARD COATING

(71) Applicants: CORNING INCORPORATED, CORNING, NY (US); DuPont Electronics, Inc., Wilmington, DE (US); Rohm and Haas Electronic Materials LLC, Marlborough, MA (US)

(72) Inventors: Lujia Bu, Southborough, MA (US); Huayun Deng, Painted Post, NY (US); Suraj S Deshpande, Windham, NH (US); Ross Stefan Johnson, Wilmington, DE (US); Ying Zhang, Horseheads, NY (US)

(21) Appl. No.: 17/631,527

(22) PCT Filed: Aug. 7, 2020
(86) PCT No.: PCT/US2020/045306

§ 371 Date: Jan. 31, 2022

Related U.S. Application Data
(60) Provisional application No. 62/992,299, filed on Mar. 20, 2020.
(60) Provisional application No. 62/883,836, filed on Aug. 7, 2019.

(51) Int. Cl. C03C 17/32

(52) U.S. Cl. CPC C03C 17/32; C03C 2217/73; C03C 2217/78

(57) ABSTRACT

Glass articles having a thin glass layer and atop optically transparent polymeric hard-coat layer disposed on atop surface of the thin glass layer. The top optically transparent polymeric hard-coat layer may have a thickness in a range of 0.1 microns to 200 microns and a pencil hardness of 6H or more, when the pencil hardness is measured with the optically transparent polymeric hard-coat layer disposed on the top surface of the glass layer. The glass articles avoid ejection of glass shard particles from the glass article upon bending to a failure during a static two-point bend test.

### BACKGROUND

### Field

The present disclosure relates to cover substrates for consumer products, for example, cover substrates for protecting a display screen, and in particular, cover substrates for consumer devices including a flexible display screen.

### Background

A cover substrate for a consumer product such as a display of an electronic device protects a display screen and provides an optically transparent surface through which a user can view the display screen. The cover substrate may also serve to reduce undesired reflections and provide an easy way to clean transparent surface. In addition, the cover substrate serves to protect sensitive components of a consumer product from mechanical damage (e.g., puncture and impact forces). For consumer products including a flexible, foldable, and/or sharply curved portion (e.g., a flexible, foldable, and/or sharply curved display screen), a cover substrate for protecting the display screen should preserve the optical transparency and flexibility, foldability, and/or curvature of the screen while also protecting the screen. Moreover, the cover substrate should resist mechanical damage, for example scratches and fracturing, so that a user can enjoy an unobstructed view of the display screen.

As a cover substrate, glass provides superior barrier to moisture (and oxygen) and hardness properties to minimize scratch and deformation damage during use. Thick monolithic glass substrates may provide adequate mechanical properties, but these substrates can be bulky and incapable of folding to tighter radii in order to be utilized in foldable, flexible, or sharply curved consumer products. And highly flexible cover substrates, for example plastic substrates, may be unable to provide adequate puncture resistance, scratch resistance, and/or fracture resistance desirable for some consumer products.

Thin glass layers offer many desirable properties for a flexible cover substrate. Glass layers can be manufactured as low thickness levels to achieve desirably smaller bend radii. Further, the bendability of a thin glass layer can be enhanced via compressive stresses introduced into surface regions of a glass layer using an ion exchange process.

However, despite the effort to make glass layers thin and flexible, such thin and flexible glass layers remain susceptible to puncture or impact forces. As a glass layer gets thinner, surface flaws present on the glass layer can have a more significant impact on the glass layer's strength. The susceptibility of thin flexible glass layers to external forces and surface flaws combined with forces induced to a glass layer during bending can increase the possibility of glass shards ejecting from a surface of the glass article during use. This possibility can be further increased by compressive stressed introduced during an ion exchange process. For various reasons, it is desirable to reduce the possibility of glass shards ejecting from the surface of a glass article. Glass shards can be safety concern, can damage other layers of a glass article, and can damage a display component underlying the glass article.

Therefore, a continuing need exists for innovations in cover substrates for consumer products, for example cover substrates for protecting a display screen, and in particular for cover substrates for consumer devices including a flexible display screen.

### BRIEF SUMMARY

The present disclosure is directed to cover substrates for protecting a flexible, foldable, or sharply curved component, for example a display component, including a polymeric hard-coat layer that does not negatively affect the flexibility or curvature of the component while also protecting the component from damaging mechanical forces. The flexible cover substrate may include a thin glass layer and a polymeric hard-coat layer disposed on the thin glass layer for providing impact and/or puncture resistance, as well as preventing ejection of glass shard particles in the event that the glass layer fractures.

A first aspect (1) of the present application is directed to a glass article. The glass article includes a glass layer having a top surface, a bottom surface, and a thickness measured from the top surface to the bottom surface in a range of 10 microns to 200 microns and a top optically transparent polymeric hard-coat layer derived from an actinic radiation curable acrylic composition and disposed on the top surface of the glass layer and having a thickness in a range of 0.1 microns to 200 microns and a pencil hardness of 6H or more, the pencil hardness being measured with the top optically transparent polymeric hard-coat layer disposed on the top surface of the glass layer. The glass article according to the first aspect avoids ejection of glass shard particles if the glass fractures under an external force and/or external impact, for example, the fracture occurs from the glass article upon bending to a failure during a static two-point bend test.

In a second aspect (2), the glass article according to the first aspect (1) is provided and the actinic radiation curable acrylic composition comprises (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt %, based on total monomer solids, of one or more radical initiators; and (e) one or more organic solvents, wherein the total amount of monomer and functional oligomer solids amounts to 100 wt %.

In a third aspect (3), the glass article according to aspect (2) is provided and the actinic radiation curable acrylic composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

In a fourth aspect (4), the glass article according to aspect (3) is provided and the actinic radiation curable acrylic composition further comprises from 2 to 30 wt. %, based on the total weight of (a), (b), (c) and (d), of one or more sulfur-containing polyol (meth)acrylates.

In a fifth aspect (5), the glass article according to aspect (3) or (4) is provided and the actinic radiation curable acrylic composition comprises from 3 to 25 wt. %, based on the total monomer solids, of one or more aliphatic trifunctional (meth)acrylate monomer, wherein the total amount of monomer and functional oligomer solids amounts to 100%.

In a sixth aspect (6), the glass article according to aby of aspects (3)-(5) is provided and the actinic radiation curable acrylic composition comprises from 3 to 25 wt. %, based on the total monomer solids, of one or more aliphatic tetrafunctional (meth)acrylate monomer, wherein the total amount of monomer and functional oligomer solids amounts to 100%.

In a seventh aspect (7), the glass article according to any of aspects (3)-(6) is provided and the actinic radiation curable acrylic composition comprises from 3 to 25 wt. %, based on the total monomer solids, of one or more aliphatic pentafunctional (meth)acrylate monomer, wherein the total amount of monomer and functional oligomer solids amounts to 100%.

In an eighth aspect (8), the glass article according to any aspects (2)-(7) is provided and the actinic radiation curable acrylic composition comprises from 10 to 30 wt. %, based on the total weight of monomer solids of the (b), wherein the total amount of monomer and functional oligomer solids amounts to 100%.

In a ninth aspect (9), the glass article according to any aspects (2)-(8) is provided and the actinic radiation curable acrylic composition comprises from 10 to 40 wt. %, based on the total weight of monomer solids of the (c), wherein the total amount of monomer and functional oligomer solids amounts to 100%.

In a tenth aspect (10), the glass article according to any aspects (2)-(9) is provided and at least one (c) aliphatic urethane (meth(acrylate functional oligomer has a weight average molecular weight of from 1,400 to 10,000 g/mol.

In an eleventh aspect (11), the glass article according to any aspects (2)-(10) is provided and the actinic radiation curable acrylic composition further comprises 20 wt. % or less, based on the total monomer solids, of one or more mono- and di-functional (meth)acrylates, wherein the total amount of monomer and functional oligomer solids amounts to 100%.

In a twelfth aspect (12), the glass article according to any aspects (2)-(11) is provided and the amount of the (e) ranges from 10 to 80 wt %, based on the total weight of the actinic radiation curable acrylic composition.

In a thirteenth aspect (13), the glass article according to any aspects (1)-(12) is provided and the top optically transparent polymeric hard-coat layer has a pencil hardness in a range of 6H to 9H, the pencil hardness being measured with the optically transparent polymeric hard-coat layer disposed on the top surface of the glass layer.

In a fourteenth aspect (14), the glass article according to any aspects (1)-(13) is provided and the pen drop height is 2 times, preferably 2.5 times, or more than that of the control pen drop height of the glass layer without the top optically transparent polymeric hard-coat layer.

In a fifteenth aspect (15), the glass article according to any of aspects (1)-(14) is provided and the top optically transparent polymer hard-coat layer has a thickness in a range of 0.1 microns to 100 microns.

In a sixteenth aspect (16), the glass article according to any of aspects (1)-(15) is provided and the glass layer has a thickness in a range of 10 microns to 100 microns.

In a seventeenth aspect (17), the glass article according to any of aspects (1)-(16) further includes a bottom optically transparent polymeric hard-coat layer disposed on the bottom surface of the glass layer, the bottom optically transparent polymeric hard-coat layer having a thickness in a range of 0.1 microns to 200 microns and a pencil hardness of 6H or more.

In an eighteenth aspect (18), the glass article according to aspect (17) is provided and the bottom optically transparent polymeric hard-coat layer is made of the same material as the top optically transparent polymeric hard-coat layer.

In a nineteenth aspect (19), the glass article according to any aspects (1)-(18) avoids failure during a static two-point bend test when held between two plates at a plate distance of 20 millimeters for 240 hours at 60° C. and 93% relative humidity.

In a twentieth aspect (20), the glass article according to any aspects (1)-(19) avoids failure during a static two-point bend test when held between two plates at a plate distance of 10 millimeters for 240 hours at 60° C. and 93% relative humidity.

In a twenty-first aspect (21), the glass article according to any aspects (1)-(20) avoids failure during a static two-point bend test when held between two plates at a plate distance of 1 millimeter for 240 hours at 60° C. and 93% relative humidity.

In a twenty-second aspect (22), the glass article according to any aspects (1)-(21) avoids failure during a dynamic two-point bend test when the glass article is cyclically bent 200,000 times between two plates to plate distance of 20 millimeters at 23° C. and 50% relative humidity.

In a twenty-third aspect (23), the glass article according to any aspects (1)-(22) avoids failure during a dynamic two-point bend test when the glass article is cyclically bent 200,000 times between two plates to plate distance of 10 millimeters at 23° C. and 50% relative humidity.

In a twenty-fourth aspect (24), the glass article according to any aspects (1)-(23) avoids failure during a dynamic two-point bend test when the glass article is cyclically bent 200,000 times between two plates to plate distance of 1 millimeter at 23° C. and 50% relative humidity.

In a twenty-fifth aspect (25), the glass article according to any aspects (1)-(24) is provided and the optically transparent polymeric hard-coat layer has a percent elongation in a range of 1% to 10%.

In a twenty-sixth aspect (26), the glass article according to any of aspects (1)-(25) is provided and the optically transparent polymeric hard-coat layer has a modulus of elasticity in a range of 1 GPa to 15 GPa.

In a twenty-seventh aspect (27), the glass article according to any of aspects (1)-(26) further comprising an adhesion promoter between the top optically transparent polymeric hard-coat layer and the top surface of the glass layer.

In a twenty-eighth aspect (28), the glass article according to any of aspects (17)-(27) is provided and the bottom surface of the glass layer further comprises an adhesion promoter between the bottom optically transparent polymeric hard-coat layer and the bottom surface of the glass layer.

In a twenty-ninth aspect (29), the glass article according to any aspects (1)-(28) further includes a coating layer disposed on a top surface of the top optically transparent polymeric hard-coat layer.

In a thirtieth aspect (30), the glass article according to aspect (29) is provided and the coating layer is selected from the group of an anti-reflection coating layer, an anti-glare coating layer, an anti-fingerprint coating layer, an anti-microbial coating layer, and an easy-to-clean coating layer.

In a thirty-first aspect (31), the glass article according to any of aspects (1)-(30) is provided and the top optically transparent polymeric hard-coat layer defines a topmost exterior surface of the glass article.

In a thirty-second aspect (32), the glass article according to any of aspects (1)-(31) is provided and the glass article is devoid of a layer disposed over the top optically transparent polymeric hard-coat layer having a pencil hardness greater than that of the optically transparent polymeric hard-coat layer.

A thirty-third aspect (33) of the present application is directed to an electronic display component. The electronic display component includes an electronic display comprising a display surface and the glass article according to any aspects (1)-(32) that is provided.

A thirty-fourth aspect (34) of the present application is directed to an article. The article includes a cover substrate including the glass article according to any aspects (1)-(32) that is provided.

In a thirty-fifth aspect (35), the article according to aspect (34) is a consumer electronic product, comprising a housing having a front surface, a back surface, and side surfaces; electrical components disposed at least partially within the housing, the electrical components including a controller, a memory, and a display, the display at or adjacent the front surface of the housing; and the cover substrate disposed over the display or forms at least a portion of the housing.

A thirtieth-sixth aspect (36) of the present application is directed to a method of making a glass article, the method including (a) coating an optically transparent polymeric hard-coat composition directly on a top surface of a glass layer including the top surface, a bottom surface, and a thickness measured from the top surface to the bottom surface in a range of 10 microns to 200 microns; and (b) polymerizing and curing the optically transparent polymeric hard-coat composition on the top surface of the glass layer to form an optically transparent polymeric hard-coat layer having a thickness in a range of 10 microns to 200 microns. The optically transparent polymeric hard-coat composition comprises (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt. %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more radical initiators; and (e) one or more organic solvents for the monomer composition, wherein the total amount of monomer and functional oligomer solids amounts to 100%.

In a thirty-seventh aspect (37), the method according to aspect (36) is provided and the optically transparent polymeric hard-coat composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

In a thirty-eighth aspect (38), the method according to aspect (37) is provided and the optically transparent polymeric hard-coat composition further comprises from 2 to 30 wt. %, based on the total weight of (a), (b), (c) and (d), of one or more sulfur-containing polyol (meth)acrylates.

In a thirty-ninth aspect (39), the method according to any of aspects (36)-(38) is provided and includes coating the top surface of the glass layer with an adhesion promoter prior to applying the optically transparent polymeric hard-coat precursor layer on the top surface.

A fortieth aspect (40) of the present application is directed to a method of making a glass article, the method including (a) providing an optically transparent polymeric layer having a thickness in a range of 0.1 microns to 200 microns; and (b) laminating the optically transparent polymeric hard-coat layer on a top surface of a glass layer having a thickness in a range of 10 microns to 200 microns. The optically transparent polymeric hard-coat layer is made from polymerizing and curing an acrylic composition comprising (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt. %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more radical initiators; and (e) one or more organic solvents for the monomer composition, wherein the total amount of monomer and functional oligomer solids amounts to 100%.

In a forty-first aspect (41), the method according to aspect (40) is provided and the optically transparent polymeric hard-coat composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

In a forty-second aspect (42), the method according to aspect (41) is provided and the optically transparent polymeric hard-coat composition further comprises from 2 to 30 wt. %, based on the total weight of (a), (b), (c) and (d), of one or more sulfur-containing polyol (meth)acrylates.

In a forty-third aspect (43), the method according to any of aspects (40)-(42) includes adding the top surface of the glass layer with an adhesion promoter prior to the lamination.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a glass article according to some embodiments.

FIG. 2 illustrates a glass article according to some embodiments.

FIG. 3A illustrates a cross-sectional view of a glass article according to some embodiments.

FIG. 3B illustrates a cross-sectional view of a glass article according to some embodiments.

FIG. 4 illustrates a cross-sectional view of a glass article according to some embodiments upon bending of the glass article.

FIG. 5 illustrate a glass article including a coating layer according to some embodiments.

FIG. 6 illustrates a consumer product according to some embodiments.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The term “or,” as used herein, is inclusive; more specifically, the phrase “A or B” means “A, B, or both A and B.” Exclusive “or” is designated herein by terms such as “either A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

The term “wherein” is used as an open-ended transitional phrase, to introduce a recitation of a series of characteristics of the structure.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

The terms “substantial,” “substantially,” and variations thereof as used herein are intended to note that a described feature is equal or approximately equal to a value or description. For example, a “substantially planar” surface is intended to denote a surface that is planar or approximately planar.

As used herein the term “glass” is meant to include any material made at least partially of glass, including glass and glass-ceramics. “Glass-ceramics” include materials produced through controlled crystallization of glass.

As used herein, the terms “top surface” or “topmost surface” and “bottom surface” or “bottommost surface” reference the top and bottom surface of a layer or article as is would be oriented on a device during its normal and intended use with the top surface being the user-facing surface. For example, when incorporated into a hand-held consumer electronic product having an electronic display, the “top surface” of a glass article refers to the top surface of that article as it would be oriented when held by a user viewing the electronic display through the glass article.

“Alkyl” refers to linear, branched and cyclic alkyl unless otherwise specified. The term “oligomer” refers to dimers, trimers, tetramers and other polymeric materials that are capable of further curing. By the term “curing” is meant any process, such as polymerization or condensation, that increases the molecular weight of a material composition. “Curable” refers to any material capable of being cured under the conditions of use. The term “film” and “layer” are under interchangeably through this specification. The term “(meth)acrylate” refers to any of a “methacrylate”, an “acrylate”’ and combinations thereof. The term “copolymer” refers to a polymer composed of two or more different monomers as polymerized units, and includes terpolymers, tetrapolymers, and the like.

Cover substrates such as cover glass disclosed herein may be incorporated into another article, for example, an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance, or a combination thereof. An exemplary article incorporating any of the glass articles disclosed herein is a consumer electronic device including a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display. In some embodiments, the cover substrate may include any of the glass articles disclosed herein. In some embodiments, at least one portion of the housing or the cover substrate comprises a glass article as disclosed herein.

Glass articles described herein include a glass layer and an optically transparent polymeric hard-coat layer disposed on one or more surfaces of the glass layer. The optically transparent hard-coat materials described herein have good yield strength and elastic deformation properties. When applied in direct contact with a surface of a glass layer, it was discovered that these properties make them capable of containing glass shard fragments during a glass layer failure resulting from an external force and/or impact such as a bending event. This combination prevents ejection of glass shard particles in the event that the glass layer fractures, and increases the puncture and/or impact resistance of a glass layer. By providing puncture and impact resistance, and by preventing ejection of glass shard particles, the polymeric hard-coat(s) may reduce the number, and/or thicknesses, of coating layers for manufacturing a flexible cover substrate capable of adequately protecting sensitive components of a consumer product from mechanical damage during use. Decreasing the number of coating layers may also eliminate any inflexibility added by additional layers. By preventing ejection of glass shard particles, the polymeric hard-coat layer(s) may improve shatter resistance at thicknesses significantly thinner than a glass layer, thus facilitating the flexibility of a glass article.

Transparent polymeric hard-coat layers disposed on glass layers as described herein can provide one or more of the following advantages. (1) They can reduce surface flaws caused by routine device usage. (2) When applied to a top and/or bottom surface of a glass layer, they can increase the impact and puncture resistance without jeopardizing transparency and bendability (flexibility) of the glass. (3) When applied to the top and/or bottom surface of a glass layer, they can prevent ejection of glass shard particles in the event that the glass layer fractures upon being bent beyond its designed limits, for example. In other words, the top and/or bottom polymeric layer may prevent ejection of glass shard particles from the glass layer in the event that the glass layer fractures. (4) Compared to a hard coating disposed on another polymer layer or adhesive layer, the polymeric hard-coats directly coated on a surface of a glass layer have a much higher pencil hardness. This can provide superior scratch resistance. (5) Because the optically transparent polymeric hard-coat is applied directly on a rigid glass surface, dimple formation is minimal after an impact event as long as any deformation of the hard-coat material is within the material's elastic deformation range. It was discovered that a glass layer will fail before the optically transparent polymeric hard-coat. (6) Since the optically transparent polymeric hard-coats are directly coated on a glass surface, they can improve a glass layer's bending performance by introducing a compressive stress created by shrinkage of a polymeric hard-coat precursor during curing. (7) The polymeric-hard coating applied directly on a glass surface resists delamination, fracture, and crease because there is no polymer interlayers or adhesives. Much less residual warp is observed after various bending events.

The polymeric hard-coat layers discussed herein are disposed on a surface of a glass layer (for example, formed or deposited on the glass surface). As used herein, “disposed on” means that a first layer and/or component is in direct contact with a second layer and/or component. A first layer and/or component “disposed on” a second layer and/or component may be deposited, formed, placed, or otherwise applied directly onto the second layer and/or component. In other words, if a first layer and/or component is disposed on a second layer and/or component, there are no layers disposed between the first layer and/or component and the second layer and/or component. A surface treatment, for example an adhesion promoting surface treatment, is not considered a layer or component disposed between a first layer and/or component and a second layer and/or component. If a first layer and/or component is described as “disposed over” a second layer and/or component, other layers may or may not be present between the first layer and/or component and the second layer and/or component.

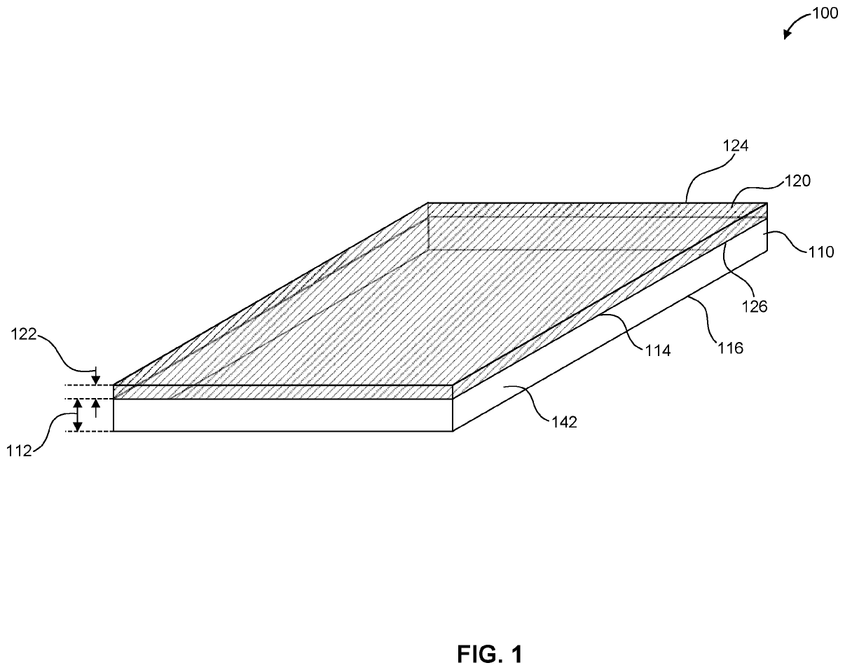

FIG. 1 illustrates a glass article 100 according to some embodiments. Glass article 100 may include a glass layer 110 and an optically transparent polymeric hard-coat layer 120 disposed on a top surface 114 of glass layer 110. Optically transparent polymeric hard-coat layer 120 may also be referred to as a “top optically transparent hard-coat layer.”

Glass layer 110 has a thickness 112 measured from top surface 114 to bottom surface 116 of glass layer 110. In some embodiments, thickness 112 may be in a range of 0.1 microns (micrometers, μm) to 200 microns, including subranges. For example, glass layer 110 may have a thickness 112 of 0.1 microns, 0.5 microns, 1 micron, 10 microns, 20 microns, 25 microns, 30 microns, 40 microns, 50 microns, 60 microns, 70 microns, 75 microns, 80 microns, 90 microns, 100 microns, 125 microns, 150 microns, 175 microns, or 200 microns, or within a range having any two of these values as endpoints, inclusive of the endpoints. For example, in some embodiments, thickness 112 may be in the range of 10 microns to 100 microns.

In some embodiments, glass layer 110 may have a thickness 112 in the range of 10 microns to 125 microns. For example, glass layer 110 may have a thickness 112 of 10 microns, 20 microns, 25 microns, 30 microns, 40 microns, 50 microns, 60 microns, 70 microns, 80 microns, 90 microns, 100 microns, 110 microns, 120 microns, or 125 microns, or within a range having any two of these values as endpoints, inclusive of the endpoints.

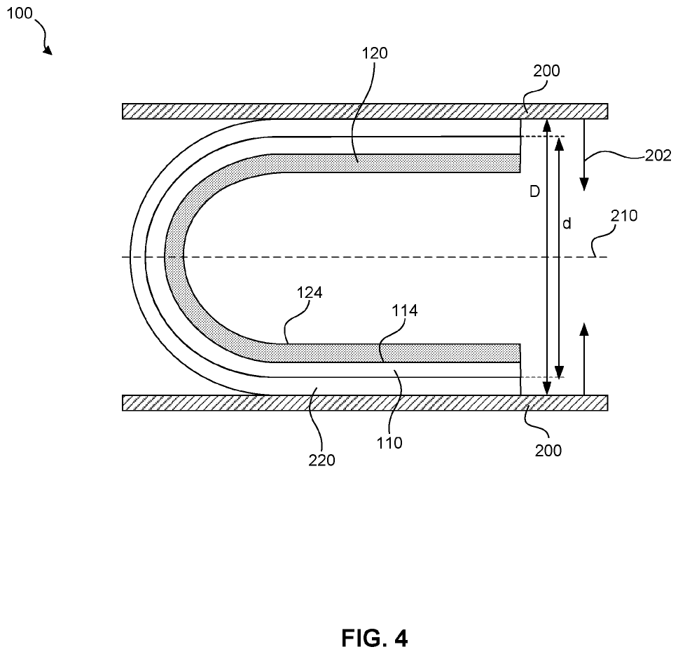

In some embodiments, glass layer 110 may be an ultra-thin glass layer. As used herein, the term “ultra-thin glass layer” means a glass layer having a thickness 112 in the range of 0.1 microns to 75 microns. In some embodiments, glass layer 110 may be a flexible glass layer. As used herein, a “flexible” glass layer 110, glass article 100, or component is a layer, article, or component characterized by the ability of the glass layer 110, glass article 100, or component to avoid failure during a static two-point bend test when held between two plates at a plate distance of 20 millimeters (mm) for 240 hours at 60° C. and 93% relative humidity. A plate distance is the linear distance in a straight line between opposing exterior surfaces of a glass layer 110, glass article 100, or substrate during a two-point bend test. For example, “D” represents the plate distance for glass article 100 bonded to a substrate 220 in FIG. 4 and “d” represents the plate distance for glass layer 110.

In some embodiments, glass layer 110 may be a non-strengthened glass layer, for example a glass layer that has not been subject to an ion exchange process or a thermal tempering process. In some embodiments, glass layer 110 may have been subject to an ion exchange process. In such embodiments, the glass layer may be referred to as an ion-exchanged glass layer. The ion exchange process results in glass layer 110 having a compressive stress on at least one of top surface 114 and/or bottom surface 116 of glass layer 110, and a concentration of a metal oxide that is different at least two points through the thickness of glass layer 110. The metal oxide may be an alkali metal oxide. The concentration difference may be 0.2 mol % or more. For example, in some embodiments, the concentration difference may be in the range of 0.2 mol % to 2 mol %.

In some embodiments, glass layer 110 may be an optically transparent glass layer. As used herein, “optically transparent” means a minimum transmittance of 70% or more in the wavelength range of 400 nm to 700 nm through a 200 microns thick piece of a material. In some embodiments, an optically transparent material may have a minimum transmittance of 75% or more, 80% or more, 85% or more, or 90% or more in the wavelength range of 400 nm to 700 nm through a 200 microns thick piece of the material. The minimum transmittance in the wavelength range of 400 nm to 700 nm is calculated by measuring the transmittance of all whole number wavelengths from 400 nm to 700 nm and selecting the smallest transmittance percentage value. Unless specified otherwise, optical transparency is measured by a spectrophotometer, for example a Color i7 spectrophotometer available from X-Rite or an equivalent device.

In some embodiments, the top optically transparent polymeric hard-coat layer 120 may comprise a cured acrylate resin material derived from an actinic radiation curable acrylic composition. The actinic radiation curable acrylic composition can comprise (a) one or more, or two or more, or all three multifunctional (meth)acrylate diluents chosen from (a1) an aliphatic trifunctional (meth)acrylate, preferably, acrylate, monomer, (a2) an aliphatic tetrafunctional (meth)acrylate monomer, or (a3) an aliphatic pentafunctional (meth)acrylate preferably, acrylate, monomer; (b) from 3 to 30 wt. %, or from 10 to 30 wt. %, based on the total weight of monomer solids, of one or more one (meth)acrylate, preferably, acrylate, monomer containing an isocyanurate group; (c) from 5 to 60 wt. %, or from 5 to 55 wt. %, or from 10 to 50 wt. % or from 5 to 40 wt. %, or from 10 to 40 wt. % based on the total weight of monomer solids, of one or more aliphatic urethane (meth)acrylate, preferably, acrylate, functional oligomer having no fewer than 6 and up to 24, or from 6 to 12, or from 6 to 10 (meth)acrylate, preferably, acrylate, groups; (d) from 2 to 10 wt. %, or from 3 to 8 wt. %, or from 3 to 7 wt. % based on total monomer solids, of one or more radical initiators, wherein the total amount of monomer and functional oligomer solids amounts to 100 wt. %. The actinic radiation curable acrylic composition can further comprise (e) one or more organic solvents.

In some embodiments, the actinic radiation curable acrylic composition can comprise from 9 to 70 wt. %, or from 9 to 60 wt. %, or from 3 to 30 wt. % or from 3 to 20 wt %, or from 3 to 15 wt. % of (a) one or more, or two or more, or all three multifunctional (meth)acrylate diluents chosen from (a1) an aliphatic trifunctional (meth)acrylate, preferably, acrylate, monomer (a2) an aliphatic tetrafunctional (meth)acrylate monomer; or (a3) an aliphatic pentafunctional (meth)acrylate.

The radical initiators can include, but are not limited to, benzophenones, benzils (1,2-diketones), thioxanthones, (2-benzyl-2-dimethylamino-1-[4-(4-morpholinyl)phenyl]-1-butanone), 2,4,6-trimethyl-benzoyl)-diphenyl phosphine oxide, 1-hydroxy-cyclohexyl-pheny 1-ketone, 2-hydroxy-2-methyl-1-phenyl-1-propanone), oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, and bis-benzophenones, or, preferably, oligomeric 2-hydroxy-2-methyl-1-[4-(1-methylvinyl)phenyl]propanones, dihydro-5-(2-hydroxy-2-methyl-1-oxopropyl)-1,1,3-trimethyl-3-(4-(2-hydroxy-2-methyl-1-oxopropyl)phenyl)-1H-indenes, or α-[(4-benzoylphenoxy)-acetyl]-ω-[[2-(4-benzoylphenoxy)-acetyl]oxy]-poly(oxy-1,4-butanediyl)).

The organic solvents can include, but are not limited to, a ketone such as methyl ethyl ketone; an ether; an aliphatic or aromatic hydrocarbon; an aromatic alcohol or an alkanol, an ester, or the combination of the multiple functional groups on one chain, such as hydroxy ketone or propylene glycol methyl ether acetate. The composition can comprise 10 to 90 wt. %, or from 25 to 60 wt. % of the organic solvents, based on the total weight of the composition.

The composition has a viscosity measured in accordance with ASTM D7042-16 (2016) using a viscometer (ASVM3001, Anton Parr, Ashland, Va.) at 25° C. and at 50 wt. % solids in the organic solvent, such as propylene glycol methyl ether acetate (PGMEA), ranging from 10 to 2000 centipoise (cPs), or from 20 to 400 cPs, of from 10 to 200 cPs, or from 20 to 150 cPs, wherein the total amount of monomer and functional oligomer solids amounts to 100%.

In one embodiment, the actinic radiation curable acrylic composition comprises (a) a multifunctional (meth)acrylate diluent of the (a1) one or more aliphatic trifunctional (meth)acrylate, preferably, acrylate, monomer, in the amount of from 3 to 25 wt. %, or from 3 to 20 wt. %, or from 3 to 15 wt. %, based on total monomer solids, wherein the total amount of monomer and functional oligomer solids amounts to 100%.

In another embodiment, the actinic radiation curable acrylic composition comprises (a) a multifunctional (meth)acrylate diluent of the (a2) one or more aliphatic tetrafunctional (meth)acrylate, preferably, acrylate, monomer, in the amount of from 3 to 25 wt. %, or from 3 to 20 wt. %, or from 3 to 15 wt. %, based on total monomer solids, wherein the total amount of monomer and functional oligomer solids amounts to 100%.

In yet another embodiment, the actinic radiation curable acrylic composition comprises (a) a multifunctional (meth)acrylate diluent of the (a3) one or more aliphatic pentafunctional (meth)acrylate, preferably, acrylate, monomer, in the amount of from 3 to 25 wt. %, or from 3 to 20 wt %, or from 3 to 15 wt. %, based on total monomer solids, wherein the total amount of monomer and functional oligomer solids amounts to 100%.

In some embodiments, the actinic radiation curable acrylic composition comprises at least one (c) aliphatic urethane (meth)acrylate functional oligomer has a formula molecular weight of from 1400 to 10000, or from 1500 to 6000 g/mol, wherein the reacted isocyanate (carbamate) content of the composition, as solids, of the one or more (c) aliphatic urethane (meth)acrylate, preferably, acrylate, functional oligomer ranges from 5 to 60, or from 10 to 50 wt. %.

The actinic radiation curable acrylic compositions of the present application further comprises from 0.1 to 30 wt. %, or from 1 to 30 wt %, or from 2 to 30 wt. %, or from 3 to 30 wt. %, or from 10 to 30 wt. %, or from 3 to 25 wt. %, from 5 to 25 wt. %, or from 3 to 20 wt. % based on the total weight of (a), (b), (c) and (d), of one or more thiol compounds of sulfur-containing polyol (meth)acrylates, or thiols not containing (meth)acrylate. Such compounds can be used to promote the surface cure of the actinic radiation cured coatings made from the present compositions. Suitable sulfur-containing polyol (meth)acrylates have at least 2, or at least 3, or 6 or fewer, or 5 or fewer, or from 2 to 6, (meth)acrylate functional groups. An exemplary sulfur-containing polyol (meth)acrylates can be a mercapto modified polyester acrylate, sold as EBECRYL™ LED 02 or LED 01 (Allnex Coating Resins, Frankfurt am Main, Germany).

The actinic radiation curable acrylic composition comprises in total 5 wt. % or less, or 3.5 wt. % or less, as solids, of inorganic nanoparticle compounds, such as fillers, for example silica, alumina, ceria, titania, zirconia or any suitable metal or metal oxide nanoparticles having an average particle size of 1000 nm or less in diameter for the primary particle size, or 500 nm or less, or 100 nm or less at the longest dimension, measured by Brunauer-Emmett-Teller analyzer. The nanoparticles can be symmetric, such as sphere, or non-symmetric, such as rod. They can be solid or hollow, or mesoporous. The nanoparticles may be individually dispersed or can be dispersed as aggregates in the composition. When the nanoparticles used are agglomerates, they have a secondary average particle size of less than 10000 nm, as measured by dynamic laser light scattering.

The actinic radiation curable acrylic composition of the present disclosure may be coated directly on top surface 114 of glass layer 110 in FIG. 1 at suitable temperatures, such as from 20 to 150° C., or from 60 to 150° C. Coating can be carried out by any suitable means such as, but not limited to, drawdown bar coating, wire bar coating, slit coating, flexographic printing, imprinting, spray coating, dip coating, spin coating, flood coating, screen printing, inkjet printing, gravure coating, and the like. In some embodiments, optically transparent polymeric hard-coat layer 120 may be formed by drying the coated composition, which includes evaporating a solvent at a temperature of 50 to 200° C., or 150° C. or less, or 120° C. or less, or 100° C. or less, or 90° C. or less; and curing the dried composition through exposure to actinic radiation having a peak maximum in a range of from 100 to 600 nm, or from 150 nm to 600 nm, or from 190 nm to 600 nm, (ultraviolet to visible light ranges).

Suitable radiation is present, for example, in Sunlight or light from artificial light sources. Light sources are not particularly limited and may be appropriately selected depending on the purpose. Both point Sources and arrays (“lamp carpets’) are suitable. Examples thereof include carbon arc lamps, Xenon arc lamps, low medium-, high- and Superhigh-pressure mercury lamps, possibly with metal halide dopes (metal-halogen lamps), micro wave-stimulated metal vapor lamps, excimer lamps, Super actinic fluorescent tubes, fluorescent lamps, argon incandescent lamps, electronic flashlights, photographic flood lamps, light emitting diodes (LED), electron beams and X-rays. The particular wavelength used will depend on the particular radical initiator(s) used in the composition. Such wavelength selection and light dosages are well within the ability of those skilled in the art. The light dosages used in the present composition can be varied from, 30 to 8,000 millijoules per centimeter squared (mJ/cm²), 200 to 8,000 mJ/cm², or from 400 to 6,000 mJ/cm², or from 500 to 5,000 mJ/cm², or from 550 to 3,000 mJ/cm². In one embodiment, a Fusion Systems ultraviolet (UV) belt system device (Heraeus Noblelight American, LLC, Gaithersburg, Md.) equipped with D lamp at a speed of 0.24 m/s is used.

In some embodiments, prior to coating the actinic radiation curable acrylic composition directly on top surface 114 of glass layer 110 in FIG. 1, an adhesion promoter may be coated on top surface 114. The adhesion promoter may improve the bond between top surface 114 of glass layer 110 and bottom surface 126 of top optically transparent polymeric hard-coat layer 120, thereby improving the mechanical strength of the interface between top surface 114 and bottom surface 126. The adhesion promoter utilized may be selected based on the material of optically transparent polymeric hard-coat layer 120. A wide variety of adhesion promoters may be used and well-known in the art. Examples of the adhesion promoters can include, but are not limited to, a silane coupling agent such as 3-acryloxypropyl trimethoxy silane, methyltrimethoxy silane, aminopropyl trimethoxy silane, 8-methacryloxyoctyltrimethyoxy silane, ((chloromethyl)phenylethyl) trichloro silane, 1,2-bis(triethoxysilyl)ethane and N,N′-bis[3-(trimethyoxysilyl)propyl]ethylenediamine; and polyetheramines such as JEFFAMINE™ D230 and JEFFAMINE™ T403 (commercially available from Huntsman).

In one embodiment, (3-acryloxypropyl) trimethoxysilane is an adhesion promoter A silane solution may be prepared by mixing 0.1 wt. % of silane in acidified ethyl alcohol (pH 4.5-5.5 with acetic acid) and stirring 5 to 10 minutes. The silane solution can be applied to a surface of glass layer 110 by for example, spin coating, dip-coating, spray coating, or vapor priming. Excess silanes are washed away from top surface 114 using ethanol. Then the glass layer 110 may be subjected to a post-application baking process at 120° C. for 1 min. The actinic radiation curable acrylic composition and preparation are disclosed in U.S. Patent Application Publication No. 2019/0185602, published on Dec. 15, 2017, which is hereby incorporated by reference in its entirety by reference thereto.

Top optically transparent polymeric hard-coat layer 120 has a thickness 122 measured from a top surface 124 to a bottom surface 126 of optically transparent polymeric hard-coat layer 120. In some embodiments, thickness 122 may be in the range of 0.1 microns to 200 microns, including subranges. For example, thickness 122 may be 0.1 microns, 0.5 microns, 1 micron, 5 microns, 10 microns, 20 microns, 25 microns, 30 microns, 40 microns, 50 microns, 60 microns, 70 microns, 75 microns, 80 microns, 90 microns, 100 microns, 110 microns, 120 microns, 125 microns, 130 microns, 140 microns, 150 microns, 160 microns, 170 microns, 175 microns, 180 microns, 190 microns, or 200 microns, or within a range having any two of these values as endpoints, inclusive of the endpoints. In some embodiments, thickness 122 of optically transparent polymeric hard-coat layer 120 may be in the range of 0.1 microns to 100 microns.

Top optically transparent polymeric hard-coat layer 120 has a pencil hardness of 6H or more when the pencil hardness of hard-coat layer 120 is measured with hard-coat layer 120 disposed on top surface 114 of glass layer 110. In some embodiments, optically transparent polymeric hard-coat layer 120 may have a pencil hardness in the range of 6H to 9H when the pencil hardness of hard-coat layer 120 is measured with hard-coat layer 120 disposed on top surface 114 of glass layer 110, including subranges. For example, the pencil hardness of optically transparent polymeric hard-coat layer 120 may be 6H, 7H, 8H, or 9H, or within a range having any two of these values as endpoints, inclusive of the endpoints. Unless specified otherwise, the pencil hardness of hard-coat layer 120 with hard-coat layer 120 disposed on top surface 114 of glass layer 110 is measured using a Gardco HA-3363 pencil hardness tester according to Japanese Standard JIS K 5600-5-4 with a test load of 750 grams.

Top optically transparent polymeric hard-coat layer 120 disposed on a surface of glass layer 110 as described herein has superior pencil hardness than the same optically transparent hard-coat layer disposed on a surface of relatively soft polymer substrate or layer, when the pencil hardness of the hard-coat layer is measured with the hard-coat layer disposed on the surface of the soft polymer substrate or layer. For example, hard-coat layer 120 disposed on a surface of glass layer 110 has a superior pencil hardness than the same layer disposed on a surface a PET (polyethylene terephthalate) or PI (polyimide) substrate having a pencil hardness of 2H As another example, hard-coat layer 120 disposed on a surface of glass layer 110 has a superior pencil hardness than the same layer disposed on a surface of a PET or PI layer forming part of a substrate that also includes a glass layer. The substrate includes the PET or PI layer disposed on the glass layer and the PET or PI layer has a pencil hardness of 3H when disposed on the glass layer. In some embodiments, hard-coat layer 120 disposed on a surface of glass layer 110 may have a pencil hardness of 2 times or more than the same layer disposed on a surface a PET or PI substrate or layer.

In some embodiments, top optically transparent polymeric hard-coat layer 120 may have a percent elongation in a range of 1% to 10% at break, including subranges. For example, top optically transparent polymeric hard-coat layer 120 may have a percent elongation of 1%, 2%, 3%, 4%, 5%, 6%, 7%, 8%, 9%, or 10%, or a percentage within a range having any two of these values as endpoints, inclusive of the endpoints. Unless specified otherwise, a percent elongation (the elongation at break or fracture strain) of a material is determined by tensile testing in accordance with EN ISO 527. For elongation measurement, an actinic radiation curable acrylic composition of the present disclosure is coated and cured on a 50-micron PET film.

In some embodiments, top optically transparent polymeric hard-coat layer 120 may have a modulus of elasticity in a range of 1 GPa (gigapascal) to 15 GPa. For example, top optically transparent polymeric hard-coat layer 120 may have a modulus of elasticity of 1 GPa, 2 GPa, 3 GPa, 4 GPa, 5 GPa, 6 GPa, 7 GPa, 8 GPa, 9 GPa, 10 GPa, 11 GPa, 12 GPa, 13 GPa, 14 GPa, or 15 GPa, or a modulus of elasticity within a range having any two of these values as endpoints, inclusive of the endpoints. Unless specified otherwise, the modulus of elasticity of a material is measured according to ASTM E111-17.

In some embodiments, optically transparent polymeric hard-coat layer 120 may be a single monolithic layer. As used herein, “single monolithic layer” means a single integrally formed layer having a generally consistent composition across its volume.

In some embodiments, optically transparent polymeric hard-coat layer 120 may be a multiple monolithic layer. As used herein, “multiple monolithic layer” or “multiple hard-coat layer” means layer that is made by layering two or more layers of materials, or by mechanically attaching different layers.

In some embodiments, a multiple hard-coat layer comprises two hard-coat layers. An indentation elastic modulus of a second hard-coat layer (E_{B}) provided to a top surface of a glass layer is higher than an indentation elastic modulus of a first hard-coat layer (E_{A}) provided as a topmost hard-coat layer. In one embodiment, E_{B}/E_{A} can be 1.1 or more, or 1.5 or more. The first hard-coat layer has a higher toughness than the second hard-coat layer. The total thickness of the multiple hard-coat layer can be 10 microns or more, or 15 microns or more.

In some embodiments, the first hard-coat layer can be obtained from polymerizing and curing the actinic radiation curable acrylic composition of the present disclosure without addition of the nanoparticles. The second-hard coat layer can be obtained from polymerizing and curing the actinic radiation curable acrylic composition of the present disclosure with addition of the nanoparticles.

In some embodiments, the first hard-coat layer have the same polymeric material of the present disclosure. In one embodiment, the second hard-coat layer can be produced from a hard-coat composition containing an epoxy-siloxane oligomer, organic particles having an average diameter of 50 to 250 nm and a reactive carrier having one or more epoxy or oxetane moieties. The compositions and the resulting hard-coat layers are disclosed in U.S. Patent Application No. 2019/0185710, the entire contents of which are incorporated herein by reference. In another embodiment, the second hard-coat layer can be produced from a hard-coat composition comprising siloxane oligomer or siloxane oligomer with nanoparticles of silica or a metal oxide. The compositions and hard-coat layers are disclosed in U.S. Patent Application Nos. 2017/0369654 and 2019/0185633, the entire contents of which are incorporated herein by reference.

In some embodiments, top surface 124 of optically transparent polymeric hard-coat layer 120 may be a topmost exterior surface of glass article 100. In some embodiments, top surface 124 of optically transparent polymeric hard-coat layer 120 may be a topmost exterior, user-facing surface of a cover substrate defined by or including glass article 100. In some embodiments, glass article 100 may be devoid of a layer disposed over optically transparent polymeric hard-coat layer 120 having a pencil hardness greater than that of optically transparent polymeric hard-coat layer 120.

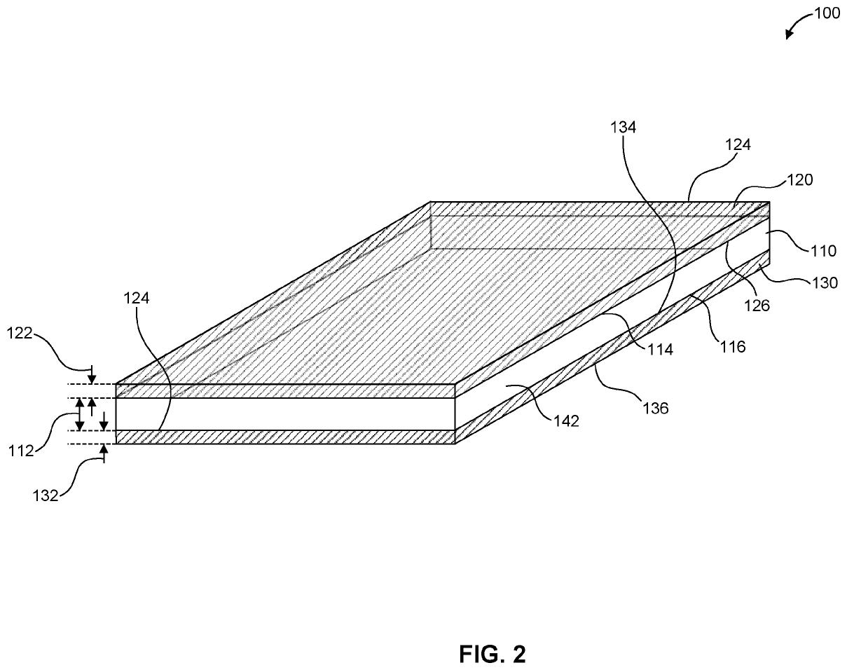

In some embodiments, as shown, for example, in FIG. 2, glass article 100 may include an optically transparent polymeric hard-coat layer 130 disposed on bottom surface 116 of glass layer 110. Optically transparent polymeric hard-coat layer 130 may be referred to as a “bottom optically transparent polymeric hard-coat layer”

Bottom optically transparent polymeric hard-coat layer 130 has a thickness 132 measured from a top surface 134 to a bottom surface 136 of bottom optically transparent polymeric hard-coat layer 130. In some embodiments, thickness 132 may be in the range of 0.1 microns to 200 microns, including subranges. For example, thickness 132 may be 0.1 microns, 0.5 microns, 1 micron, 5 microns, 10 microns, 20 microns, 25 microns, 30 microns, 40 microns, 50 microns, 60 microns, 70 microns, 75 microns, 80 microns, 90 microns, 100 microns, 110 microns, 120 microns, 125 microns, 130 microns, 140 microns, 150 microns, 160 microns, 170 microns, 175 microns, 180 microns, 190 microns, or 200 microns, or within a range having any two of these values as endpoints, inclusive of the endpoints. In some embodiments, thickness 132 of optically transparent polymeric hard-coat layer 130 may be in the range of 0.1 microns to 100 microns.

Bottom optically transparent polymeric hard-coat layer 130 has a pencil hardness of 6H or more when the pencil hardness of hard-coat layer 130 is measured with hard-coat layer 130 disposed on bottom surface 116 of glass layer 110. In some embodiments, optically transparent polymeric hard-coat layer 130 may have a pencil hardness in the range of 6H to 9H when the pencil hardness of hard-coat layer 130 is measured with hard-coat layer 130 disposed on bottom surface 116 of glass layer 110, including subranges. For example, the pencil hardness of optically transparent polymeric hard-coat layer 130 may be 6H, 7H, 8H, or 9H, or within a range having any two of these values as endpoints, inclusive of the endpoints. Unless specified otherwise the pencil hardness of hard-coat layer 130 with hard-coat layer 130 disposed on bottom surface 116 of glass layer 110 is measured using a Gardco HA-3363 pencil hardness tester according to Japanese Standard JIS K 5600-5-4 with a test load of 750 grams.

In some embodiments, bottom optically transparent polymeric hard-coat layer 130 may have a percent elongation in the range of 1% to 10% at break, including subranges. For example, the material of optically transparent polymeric hard-coat layer 130 may have a percent elongation of 1%, 2%, 3%, 4%, 5%, 6%, 7%, 8%, 9%, or 10%, or a percentage within a range having any two of these values as endpoints, inclusive of the endpoints.

In some embodiments, bottom optically transparent polymeric hard-coat layer 130 may have a modulus of elasticity in the range of 1 GPa to 15 GPa. For example, the material of optically transparent polymeric hard-coat layer 130 may have a modulus of elasticity of 1 GPa, 2 GPa, 3 GPa, 4 GPa, 5 GPa, 6 GPa, 7 GPa, 8 GPa, 9 GPa, 10 GPa, 11 GPa, 12 GPa, 13 GPa, 14 GPa, or 15 GPa, or a modulus of elasticity within a range having any two of these values as endpoints, inclusive of the endpoints.

Bottom optically transparent polymeric hard-coat layer 130 may be a single or a multiple monolithic layer. In some embodiments, bottom surface 136 of bottom optically transparent polymeric hard-coat layer 130 may be a bottommost interior surface of glass article 100. In some embodiments, bottom surface 136 of bottom optically transparent polymeric hard-coat layer 130 may be a bottommost interior surface of a cover substrate defined by or including glass article 100.

In some embodiments, bottom optically transparent polymeric hard-coat layer 130 may be made of the same material and have the same or different thickness as top optically transparent polymeric hard-coat layer 120. In some embodiments, bottom optically transparent polymeric hard-coat layer 130 may be made of a different material and have the same or different thickness as top optically transparent polymeric hard-coat layer 120.

In some embodiments, a bottom optically transparent polymeric hard-coat layer 130 comprises a multiple hard-coat layer having two hard-coat layers. An indentation elastic modulus of a second hard-coat layer (E_{B′}) provided closed to a bottom surface of a glass layer is higher than an indentation elastic modulus of a first hard-coat layer (E_{A′}) provided as a bottommost hard-coat layer. In one embodiment, E_{B′}/E_{A′} can be 1.1 or more, or 1.5 more. The first hard-coat layer has a higher toughness than the second hard-coat layer. The total thickness of the multiple hard-coat layer can be 10 microns or more, or 15 microns or more.

In some embodiments, the first hard-coat layer can be obtained from polymerizing and curing the actinic radiation curable acrylic composition of the present disclosure without addition of the nanoparticles. The second-hard coat layer can be obtained from polymerizing and curing the actinic radiation curable acrylic composition of the present disclosure with addition of the nanoparticles.

In some embodiments, the first hard-coat layer have the same polymeric material of the present disclosure. In one embodiment, the second hard-coat layer can be produced from a hard-coat composition containing an epoxy-siloxane oligomer, organic particles having an average diameter of 50 to 250 nm and a reactive carrier having one or more epoxy or oxetane moieties. The compositions and the resulting hard-coat layers are disclosed in U.S. Patent Application No. 2019/0185710, the entire contents of which are incorporated herein by reference. In another embodiment, the second hard-coat layer can be produced from a hard-coat composition comprising siloxane oligomer or siloxane oligomer with nanoparticles of silica or a metal oxide. The compositions and hard-coat layers are disclosed in U.S. Patent Application Nos. 2017/0369654 and 2019/0185633, the entire contents of which are incorporated herein by reference.

In some embodiments, an adhesion promoter may be added on to the bottom surface 116 of glass layer 110 for adhering bottom optically transparent polymeric hard-coat layer 130 directly to bottom surface 116 of glass layer 110. The adhesion promoter may improve the bond between bottom surface 116 and top surface 134 of bottom optically transparent polymeric hard-coat layer 130, thereby improving the mechanical strength of the interface between bottom surface 116 and top surface 134. The adhesion promoter are the same as those described above.

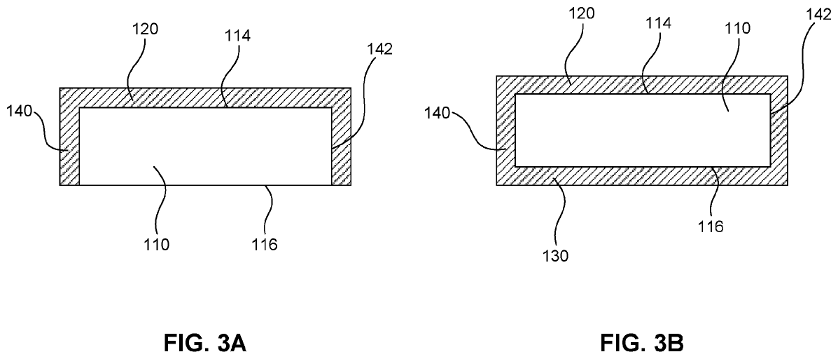

In some embodiments, as shown, for example, in FIGS. 3A and 3B, glass article may include an optically transparent polymeric hard-coat layer 140 disposed on a perimeter surface 142 of glass layer 110. Optically transparent polymeric hard-coat layer 140 may be referred to as a “perimeter optically transparent polymeric hard-coat layer.” Optically transparent polymeric hard-coat layer 140 may be coated on any or all sides of perimeter surface 142. Optically transparent polymeric hard-coat layer 140 may be the same as or similar to optically transparent polymeric hard-coat layers 120 and/or 130.

FIG. 4 illustrate a two-point in-fold bending test of a glass article 100 between two parallel plates 200 using a constant bend force 202, in which the glass article 100 is folded so as the hard-coat layer 120 to face each other. The bend force 202 is applied using a two-point bend test apparatus where two plates 200 are pressed against the glass article 100 during the in-fold bending test. Under the bend force 202, the glass article 100 deforms to an elliptic shape with variable radius of curvature, thereby experiencing bending stress with maxima at the mid-length and minima at contact lines with the parallel plates 200. If needed, fixtures associated with the test apparatus ensure that glass article 100 is bent symmetrically relative to a fold line 210 as the bend force 202 is applied to glass article 100 via plates 200. Plates 200 can be moved together in unison until a particular plate distance is achieved. As used herein, the term “failure” under a bending force refers to breakage, destruction, delamination, crack propagation, permanent deformation, or other mechanism that render an article, or a layer of the article, unsuitable for its intended purpose. Also, for a static bend test as described herein, the bend force is applied by pushing a glass article 100 between plates 200 pre-set at a specific plate distance for the static bend test.

A glass article 100 is also tested in two-point out-fold bending between two plates 200 (not shown in FIG. 4), in which the glass article 100 is folded so as the hard-coat layer 120 towards outside and facing to the plates 200. Similarly, as the in-fold bending, a constant bend force 202 is applied using a two-point bend test apparatus where two plates 200 are pressed against glass article 100 during the out-fold bending test. If needed, fixtures associated with the test apparatus ensure that glass article 100 is bent symmetrically relative to a fold line 210 as the bend force 202 is applied to glass article 100 via plates 200. Plates 200 can be moved together in unison until a particular plate distance is achieved. As used herein, the term “failure” under a bending force refers to breakage, destruction, delamination, crack propagation, permanent deformation, or other mechanism that render an article, or a layer of the article, unsuitable for its intended purpose. Also, for a static bend test as described herein, the bend force is applied by pushing a glass article 100 between plates 200 pre-set at a specific plate distance for the static bend test.

In some embodiments, glass article 100 avoids failure during a static two-point in-fold or out-fold bend test (“two-point bend test” hereinafter, referring to two-point in-fold and/or out-fold bend test) when held between two plates 200 at a plate distance of 20 mm for 240 hours at 60° C. and 93% relative humidity. In some embodiments, the glass article 100 avoids failure during a static two-point bend test when held between two plates 200 at a plate distance of 10 mm for 240 hours at 60° C. and 93% relative humidity. In some embodiments, glass article 100 avoids failure during a static two-point bend test when held between two plates 200 at a plate distance of 1 mm for 240 hours at 60° C. and 93% relative humidity.

In some embodiments, glass article 100 avoids failure during a static two-point bend test when held between two plates 200 for 240 hours at 60° C. and 93% relative humidity at a plate distance (D) of 20 mm to 1 mm. The plate distance (D) may be for example, 20 mm, 19 mm, 18 mm, between two plates 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. Glass article 100 is not bonded to a test substrate, for example a 100 microns PET substrate by a 50 microns adhesive layer for this static bend test.

A dynamic two-point bend test is conducted when glass article 100 is cyclically bent 200,000 times between two plates from a larger plate distance (D), for example 30 mm, to plate distance (D) of 20 mm or less at 22° C. and 50% relative humidity. For example, in some embodiments, glass article 100 avoids failure during a dynamic two-point bend test when cyclically bent 200,000 times between two plates at 22° C. and 50% relative humidity to a plate distance (D) of 20 mm to 1 mm. The plate distance (D) may be for example, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. For a dynamic bend test described herein, the bend force is applied by cyclically bending a glass article between plates 200 to the pre-set plate distance at a rate of 30 cycles per minute.

In some embodiments, glass article 100 avoids failure during a dynamic two-point bend test when glass article 100 is cyclically bent 200,000 times between two plates to plate distance (D) of 20 mm at 22° C. and 50% relative humidity. In some embodiments, glass article 100 avoids failure during a dynamic two-point bend test when glass article 100 is cyclically bent 200,000 times between two plates to plate distance (D) of 10 mm at 22° C. and 50% relative humidity. In some embodiments, glass article 100 avoids failure during a dynamic two-point bend test when glass article 100 is cyclically bent 200,000 times between two plates to plate distance (D) of 1 mm at 23° C. and 50% relative humidity. Glass article 100 is not bonded to a test substrate, for example a 100 microns PET substrate by a 50 microns adhesive layer for this dynamic bend test.

In some embodiments, glass article 100 may have an impact resistance defined by the capability of glass article 100 to avoid failure at a pen drop height that is “Y” times or more than that of a control pen drop height of a glass layer 110 without top optically transparent polymeric hard-coat layer 120 and/or bottom optically transparent polymeric hard-coat layer 130. In some embodiments, “Y” may be 2. In some embodiments, “Y” may be 2.5. In some embodiments, “Y” may be 3. In some embodiments, “Y” may be 3.5. In some embodiments, “Y” may be 4. The pen drop height and the control pen drop height are measured according to the following “Pen Drop Test.”

As described and referred to herein, a “Pen Drop Test” is conducted such that samples of glass articles are tested with the load (for example, from a pen dropping at a certain height) imparted to a surface of a glass article with the opposite surface of the glass article bonded to a 100-micron thick layer of polyethylene terephthalate (PET) with a 50-micron thick optically transparent adhesive layer. The PET layer in the Pen Drop Test is meant to simulate a flexible electronic display device. During testing, the glass article bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to the sample, and the tube is placed in contact with the top surface of the sample so that the longitudinal axis of the tube is substantially perpendicular to the top surface of the sample. The tube has an outside diameter of 2.54 cm (1 inch), an inside diameter of 1.4 cm (nine sixteenths of an inch) and a length of up to 90 cm. An acrylonitrile butadiene (“ABS”) shim is employed to hold the pen at a desired height for each test. After each drop, the tube is relocated relative to the sample to guide the pen to a different impact location on the sample. The pen employed in the Pen Drop Test is a BIC® Easy Glide Pen, Fine, having a tungsten carbide ball point tip of 0.7 mm diameter, and a weight of 5.8 grams including the cap (4.68 g without the cap). A comparable pen-like object with similar mass, aerodynamic properties, and a 0.7 mm diameter tungsten carbide ball tip may also be used.

For the Pen Drop Test, the pen is dropped with the cap attached to the top end (i.e., the end opposite the tip) so that the ball point can interact with the test sample. In a drop sequence according to the Pen Drop Test, one pen drop is conducted at an initial height of 1 cm, followed by successive drops in 1 cm increments up to 20 cm, and then after 20 cm, 2 cm increments until failure of the test sample. After each drop is conducted, the presence of any observable fracture, failure or other evidence of damage to the glass article is recorded along with the particular pen drop height. Using the Pen Drop Test, multiple samples can be tested according to the same drop sequence to generate a population with improved statistics. For the Pen Drop Test, the pen is to be changed to a new pen after every 5 drops, and for each new sample tested. In addition, all pen drops are conducted at random locations on the sample at or near the center of the sample, with no pen drops near or on the edge of the samples. For an “average pen drop height,” at least three samples are tested according to the Pen Drop Test and the average pen drop height is reported.

For purposes of the Pen Drop Test, “failure” means the formation of a mechanical defect in a glass article that is visible to naked eyes having 20/20 vision. The mechanical defect may be a crack or plastic deformation (e.g., surface indentation). The crack may be a surface crack or a through crack. The crack may be formed on an interior or exterior surface of a glass article. The crack may extend through all or a portion of the layers of a glass article.

A glass article of the present disclosure have a shatter resistance that can avoid ejection of glass shard particles from the glass article under an external force and/or external impact. The external force can be any force causing ejection of glass shard particles from a glass article. Examples of the external force can be included, but are not limited to, twisting the glass article, hitting the glass article with a hard object (such as hard ball and a rock), and bending the glass article.

In some embodiments, glass article 100 may have a shatter resistance defined by the capability of glass article 100 to avoid ejection of glass shard particles from the glass article upon bending to a failure during a static two-point bend test. For purposes of determining a glass article's shatter resistance, the following test is performed. An optically transparent polymeric hard-coat layer is disposed on a top, bottom, and/or perimeter surface of a glass layer 110. Then the glass article is bonded to a 100-micron thick PET test substrate (see substrate 220 in FIG. 4) with a 50-micron thick optically clear adhesive, such that the bottom surface of the glass layer faces the PET test substrate. For a test sample not including an optically transparent polymeric hard-coat layer disposed on a bottom surface of the glass layer, the bottom surface of the glass layer is directly bonded to the PET test substrate with the optically clear adhesive. After bonding to the PET test substrate, the glass article is folded between two plates 200 using a bend force 202 as illustrated in, for example, FIG. 4. FIG. 4 shows an in-fold bend configuration. In an in-fold bend, top surface 114 glass layer 110 is bent towards itself. Glass article 100 may be tested in an out-fold configuration by being bent in the opposite direction as shown in FIG. 4. In an out-fold bend, top surface 114 is bent away from itself.

A glass article 100 having a length of 160 mm and width of 100 mm is folded widthwise about the center of its length to 8 mm plate distance (D) and glass fracture is induced manually through single point sharp contact such that the glass layer 110 fractures along fold line 210. After fracture, the glass article is imaged at 20X using a microscope, for example a Zeiss digital microscope, to determine whether any glass shard particles have been ejected from the glass article. A glass shard particle ejected from the glass article is a glass shard particle generated from the fracture event that penetrated through an optically transparent hard-coat layer and is exposed or resting on an exterior surface of the glass article defined by the exterior surface of the optically transparent hard-coat layer. The sharp point used in the test can be a tungsten carbide or stainless-steel tool like dental scraper. Glass fracture is initiated at a location away from the bending region about line 210 by poking the tool through a top optically transparent hard-coat layer 120 and into glass layer 110 to cause glass fracture. The glass fracture should result in some of the fracture lines traveling to the bending region so that the glass layer 110 within the bending region fractures.

The following test parameters should be satisfied for a glass article to be characterized as having a shatter resistance defined by the capability to avoid ejection of glass shard particles. First, the glass article 100 includes only a glass layer 110 and the specified optically transparent polymeric hard-coat layer is disposed on a top, bottom, and/or perimeter surface of a glass layer 110. No other layers are present on glass article 100. For example, if a glass article is described as “comprising” one or more optically transparent polymeric hard-coat layers, only those layers are present on the glass article for a shatter resistance test. A layer or substrate present solely for purposes of testing (for example substrate 220) is not a component of a glass article for purposes of being characterized as having a shatter resistance defined by the capability to avoid ejection of glass shard particles. Second, glass article 100 should pass an in-fold test or an out-fold test. For the in-fold test, glass article 100 should avoid ejection of glass shard particles when bent in an in-fold configuration to a plate distance (D) of 8 mm. For the out-fold test, glass article 100 should avoid ejection of glass shard particles when bent in an out-fold configuration to a plate distance (D) of 8 mm.

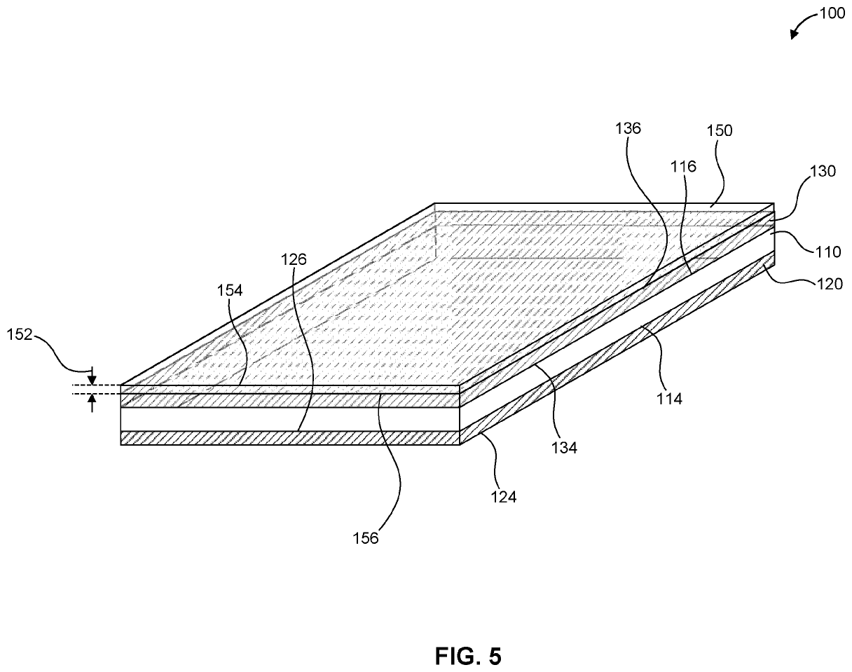

In some embodiments, for example as shown in FIG. 5, glass article 100 may be coated with a coating layer 150 having a top surface 154, a bottom surface 156, and a thickness 152. In some embodiments, coating layer 150 may disposed on top surface 124 of top optically transparent polymeric hard-coat layer 120. In some embodiments, multiple coating layers 150, of the same or different types, may be coated on a glass article 100.

In some embodiments, coating layer(s) 150 may be an anti-reflection coating layer. Exemplary materials suitable for use in the anti-reflection coating layer include: SiO₂, Al₂O₃, GeO₂, SiOₓ, AlOₓN_{y}, AlN, SiNₓ, SiOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, and other materials cited above as suitable for use in a scratch resistant layer. An anti-reflection coating layer may include sub-layers of different materials.

In some embodiments, the anti-reflection coating layer may include a hexagonally packed nanoparticle layer, for example but not limited to, the hexagonally packed nanoparticle layers described in U.S. Pat. No. 9,272,947, issued Mar. 1, 2016, which is hereby incorporated by reference in its entirety by reference thereto. In some embodiments, the anti-reflection coating layer may include a nanoporous Si-containing coating layer, for example but not limited to the nanoporous Si-containing coating layers described in WO2013/106629, published on Jul. 18, 2013, which is hereby incorporated by reference in its entirety by reference thereto. In some embodiments, the anti-reflection coating may include a multilayer coating, for example, but not limited to the multilayer coatings described in WO2013/106638, published on Jul. 18, 2013; WO2013/082488, published on Jun. 6, 2013; and U.S. Pat. No. 9,335,444, issued on May 10, 2016, all of which are hereby incorporated by reference in their entirety by reference thereto.

In some embodiments, coating layer(s) 150 may be an easy-to-clean coating layer. In some embodiments, the easy-to-clean coating layer may include a material selected from the group consisting of fluoroalkylsilanes, perfluoropolyether alkoxy silanes, perfluoroalkyl alkoxy silanes, fluoroalkylsilane-(non-fluoroalkylsilane) copolymers, and mixtures of fluoroalkylsilanes. In some embodiments, the easy-to-clean coating layer may include one or more materials that are silanes of selected types containing perfluorinated groups, for example, perfluoroalkyl silanes of formula (R_{F})_{y}SiX_{4-y}, where RF is a linear C6-C₃₀ perfluoroalkyl group, X═Cl, acetoxy, —OCH₃, and —OCH₂CH₃, and y=2 or 3. The perfluoroalkyl silanes can be obtained commercially from many vendors including Dow-Corning (for example fluorocarbons 2604 and 2634), 3MCompany (for example ECC-1000 and ECC-4000), and other fluorocarbon suppliers, for example Daikin Corporation, Ceko (South Korea), Cotec-GmbH (DURALON UltraTec materials) and Evonik. In some embodiments, the easy-to-clean coating layer may include an easy-to-clean coating layer as described in WO2013/082477, published on Jun. 6, 2013, which is hereby incorporated by reference in its entirety by reference thereto.

In some embodiments, coating layer(s) 150 may be an anti-glare layer formed on top surface 124 of optically transparent polymeric hard-coat layer 120. Suitable anti-glare layers include, but are not limited to, the anti-glare layers prepared by the processes described in U.S. Pat. Pub. Nos. 2010/0246016, 2011/0062849, 2011/0267697, 2011/0267698, 2015/0198752, and 2012/0281292, all of which are hereby incorporated by reference in their entirety by reference thereto.

In some embodiments, coating layer(s) 150 may be an anti-fingerprint coating layer. Suitable anti-fingerprint coating layers include, but are not limited to, oleophobic surface layers including gas-trapping features, as described in, for example, U.S. Pat. App. Pub. No. 2011/0206903, published Aug. 25, 2011, and oleophilic coatings formed from an uncured or partially-cured siloxane coating precursor comprising an inorganic side chain that is reactive with the surface of the glass or glass-ceramic substrate (e.g., partially-cured linear alkyl siloxane), as described in, for example, U.S. Pat. App. Pub. No. 2013/0130004, published May 23, 2013. The contents of U.S. Pat. App. Pub. No. 2011/0206903 and U.S. Pat. App. Pub. No. 2013/0130004 are incorporated herein by reference in their entirety. Other anti-fingerprint coating can include those made from compounds containing siloxane and acrylate functional groups, including fluorine-containing (meth)acryl modified organosilicon, as described in, for example, KR20110128140A, published Nov. 2, 2011, the contents of which are incorporated herein by reference in their entirety.

In some embodiments, coating layer(s) 150 may be an anti-microbial and/or anti-viral layer formed on top surface 124 of optically transparent polymeric hard-coat layer 120. Suitable anti-microbial and/or anti-viral layers include, but are not limited to, an antimicrobial Ag+ region extending from the surface of the glass article to a depth in the glass article having a suitable concentration of Ag⁺¹ ion on the surface of the glass article, as described in, for example, U.S. Pat. App. Pub. No. 2012/0034435, published Feb. 9, 2012, and U.S. Pat. App. Pub. No. 2015/0118276, published Apr. 30, 2015. The contents of U.S. Pat. App. Pub. No. 2012/0034435 and U.S. Pat. App. Pub. No. 2015/0118276 are incorporated herein by reference in their entirety.

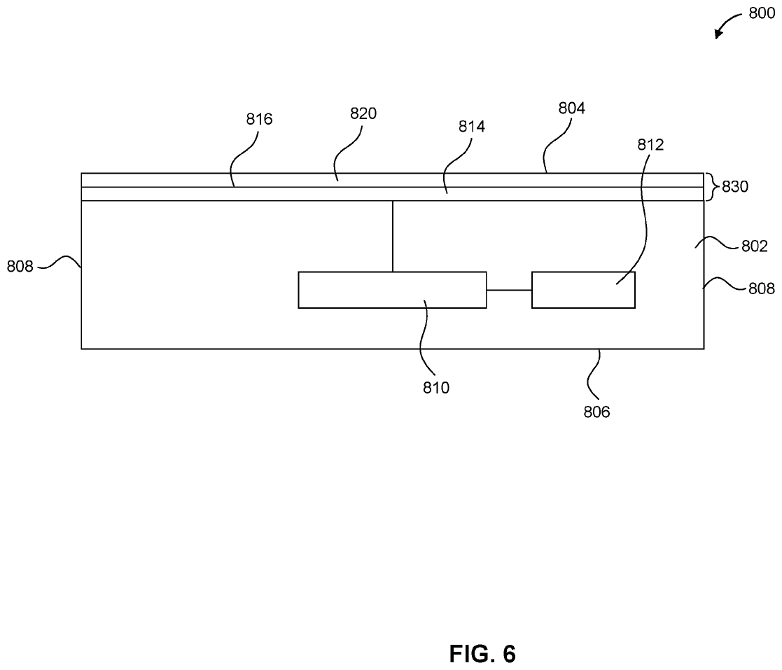

FIG. 6 shows a consumer electronic product 800 according to some embodiments. Consumer electronic product 800 may include a housing 802 having a front (user-facing) surface 804, a back surface 806, and side surfaces 808. Electrical components may be disposed at least partially within housing 802. The electrical components may include, among others, a controller 810, a memory 812, and display components, including an electronic display 814. In some embodiments, display 814 may be at or adjacent to front surface 804 of housing 802. Display 814 may be an electronic display, for example, a light emitting diode (LED) display or an organic light emitting diode (OLED) display. Display 814 includes a user-facing display surface 816 through which a user can view content displayed on display 814. Display 814 may be a flexible display.

As shown for example in FIG. 6, consumer electronic product 800 may include a cover substrate 820. Cover substrate 820 may serve to protect display 814 and other components of electronic product 800 (e.g., controller 810 and memory 812) from damage. In some embodiments, cover substrate 820 may be disposed over display surface 816 of display 814. In some embodiments, cover substrate 820 may be bonded to display 814 with an optically transparent adhesive layer. In some embodiments, cover substrate 820 may be bonded to display surface 816 with an optically transparent adhesive layer. In such embodiments, a bottommost surface of cover substrate 820 may be directly bonded to display surface 816 with an optically transparent adhesive layer.

In some embodiments, cover substrate 820 may be a cover glass defined in whole or in part by a glass article discussed herein. Cover substrate 820 may be a 2D, 2.5D, or 3D cover substrate. In some embodiments, cover substrate 820 may define front surface 804 of housing 802. In some embodiments, cover substrate 820 may define front surface 804 of housing 802 and all or a portion of side surfaces 808 of housing 802. In some embodiments, consumer electronic product 800 may include a cover substrate defining all or a portion of back surface 806 of housing 802. Together, display 814 and cover substrate 820 may define an electronic display component 830. Electronic display component 830 may be coupled to housing 802. In some embodiments, electronic display component 830 may define a portion of housing 802.

A glass layer in the present disclosure can be made of any material at least partially glass, including glass and glass-ceramics. “Glass-ceramics” include material produced through controlled crystallization of glass. In some embodiments, glass-ceramics have about 30% to about 90% crystallinity. Non-limiting examples of glass ceramic systems that may be used include Li₂O×Al₂O₃×nSiO₂ (i.e. LAS system), MgO×Al₂O₃×nSiO₂ (i.e. MAS system), and ZnO×Al₂O₃×nSiO₂ (i.e. ZAS system).

In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may either include lithia or be free of lithia. In one or more alternative embodiments, the substrate may include crystalline substrates, for example glass ceramic substrates (which may be strengthened or non-strengthened) or may include a single crystal structure, for example sapphire. In one or more specific embodiments, the substrate includes an amorphous base (e.g., glass) and a crystalline cladding (e.g., sapphire layer, a polycrystalline alumina layer and/or or a spinel (MgAl₂O₄) layer).

In some embodiments, the glass composition for glass layers discussed herein may include 40 mol % to 90 mol % SiO₂ (silicon oxide). In some embodiments, the glass composition may include 40 mol %, 45 mol %, 50 mol %, 55 mol %, 60 mol %, 65 mol %, 70 mol %, 75 mol %, 80 mol %, 85 mol %, or 90 mol % SiO₂, or a mol % within any range having any two of these values as endpoints, inclusive of the endpoints. In some embodiments, the glass composition may include 55 mol % to 70 mol % SiO₂. In some embodiments, the glass composition may include 57.43 mol % to 68.95 mol % SiO₂.

In some embodiments, the glass composition for glass layers discussed herein may include 1 mol % to 10 mol % B₂O₃ (boron oxide). In some embodiments, the glass composition may include 1 mol %, 2 mol %, 3 mol %, 4 mol %, 5 mol %, 6 mol %, 7 mol %, 8 mol %, 9 mol %, or 10 mol % B₂O₃, or a mol % within any range having any two of these values as endpoints, inclusive of the endpoints. In some embodiments, the glass composition may include 3 mol % to 6 mol % B₂O₃. In some embodiments, the glass composition may include 3.86 mol % to 5.11 mol % B₂O₃. In some embodiments, the glass composition may not include B₂O₃.

In some embodiments, the glass composition for glass layers discussed herein may include 5 mol % to 30 mol % Al₂O₃(aluminum oxide). In some embodiments, the glass composition may include 5 mol %, 10 mol %, 15 mol %, 20 mol %, 25 mol %, or 30 mol % Al₂O₃, or a mol % within any range having any two of these values as endpoints, inclusive of the endpoints. In some embodiments, the glass composition may include 10 mol % to 20 mol % Al₂O₃. In some embodiments, the glass composition may include 10.27 mol % to 16.10 mol % Al₂O₃.

In some embodiments, the glass composition for glass layers discussed herein may include 1 mol % to 10 mol % P₂O₅ (phosphorus oxide). In some embodiments, the glass composition may include 1 mol %, 2 mol %, 3 mol %, 4 mol %, 5 mol %, 6 mol %, 7 mol %, 8 mol %, 9 mol %, or 10 mol % P₂O₅, or a mol % within any range having any two of these values as endpoints, inclusive of the endpoints. In some embodiments, the glass composition may include 2 mol % to 7 mol % P₂O₅. In some embodiments, the glass composition may include 2.47 mol % to 6.54 mol % P₂O₅. In some embodiments, the glass composition may not include P₂O₅.

In some embodiments, the glass composition for glass layers discussed herein may include 5 mol % to 30 mol % Na₂O (sodium oxide). In some embodiments, the glass composition may include 5 mol %, 10 mol %, 15 mol %, 20 mol %, 25 mol %, or 30 mol % Na₂O, or a mol % within any range having any two of these values as endpoints, inclusive of the endpoints. In some embodiments, the glass composition may include 10 mol % to 20 mol % Na₂O. In some embodiments, the glass composition may include 10.82 mol % to 17.05 mol % Na₂O.

In some embodiments, the glass composition for glass layers discussed herein may include 0.01 mol % to 0.05 mol % K₂O (potassium oxide). In some embodiments, the glass composition may include 0.01 mol %, 0.02 mol %, 0.03 mol %, 0.04 mol %, or 0.05 mol % K₂O, or a mol % within any range having any two of these values as endpoints, inclusive of the endpoints. In some embodiments, the glass composition may include 0.01 mol % K₂O. In some embodiments, the glass composition may not include K₂O.

In some embodiments, the glass composition for glass layers discussed herein may include 1 mol % to 10 mol % MgO (magnesium oxide). In some embodiments, the glass composition may include 1 mol %, 2 mol %, 3 mol %, 4 mol %, 5 mol %, 6 mol %, 7 mol %, 8 mol %, 9 mol %, or 10 mol % MgO, or a mol % within any range having any two of these values as endpoints, inclusive of the endpoints. In some embodiments, the glass composition may include 2 mol % to 6 mol % MgO. In some embodiments, the glass composition may include 2.33 mol % to 5.36 mol % MgO. In some embodiments, the glass composition may not include MgO.

In some embodiments, the glass composition for glass layers discussed herein may include 0.01 mol % to 0.1 mol % CaO (calcium oxide). In some embodiments, the glass composition may include 0.01 mol %, 0.02 mol %, 0.03 mol %, 0.04 mol %, 0.05 mol %, 0.06 mol %, 0.07 mol %, 0.08 mol %, 0.09 mol %, or 0.1 mol % CaO, or a mol % within any range having any two of these values as endpoints, inclusive of the endpoints. In some embodiments, the glass composition may include 0.03 mol % to 0.06 mol % CaO. In some embodiments, the glass composition for glass layers discussed herein may include 0.01 mol % to 5 mol % CaO. In some embodiments, the glass composition may include 0.01 mol %, 0.1 mol %, 0.5 mol %, 1 mol %, 1.5 mol %, 2 mol %, 2.5 mol %, 3 mol %, 3.5 mol %, 4 mol %, 4.5 mol %, or 5 mol % CaO, or a mol % within any range having any two of these values as endpoints, inclusive of the endpoints. In some embodiments, the glass composition may not include CaO.

In some embodiments, the glass composition for glass layers discussed herein may include 0.01 mol % to 0.05 mol % Fe₂O₃ (iron oxide). In some embodiments, the glass composition may include 0.01 mol %, 0.02 mol %, 0.03 mol %, 0.04 mol %, or 0.05 mol % Fe₂O₃, or a mol % within any range having any two of these values as endpoints, inclusive of the endpoints. In some embodiments, the glass composition may include 0.01 mol % Fe₂O₃. In some embodiments, the glass composition may not include Fe₂O₃.

In some embodiments, the glass composition for glass layers discussed herein may include 0.5 mol % to 2 mol % ZnO (zinc oxide). In some embodiments, the glass composition may include 0.5 mol %, 1 mol %, 1.5 mol %, or 2 mol % ZnO, or a mol % within any range having any two of these values as endpoints, inclusive of the endpoints. In some embodiments, the glass composition may include 1.16 mol % ZnO. In some embodiments, the glass composition may not include ZnO.

In some embodiments, the glass composition for glass layers discussed herein may include 1 mol % to 10 mol % Li₂O (lithium oxide). In some embodiments, the glass composition may include 1 mol %, 2 mol %, 3 mol %, 4 mol %, 5 mol %, 6 mol %, 7 mol %, 8 mol %, 9 mol %, or 10 mol % Li₂O, or a mol % within any range having any two of these values as endpoints, inclusive of the endpoints. In some embodiments, the glass composition may include 5 mol % to 7 mol % Li₂O. In some embodiments, the glass composition may include 6.19 mol % Li₂O. In some embodiments, the glass composition may not include Li₂O.

In some embodiments, the glass composition for glass layers discussed herein may include 0.01 mol % to 0.3 mol % SnO₂ (tin oxide). In some embodiments, the glass composition may include 0.01 mol %, 0.05 mol %, 0.1 mol %, 0.15 mol %, 0.2 mol %, 0.25 mol %, or 0.3 mol %, SnO₂, or a mol % within any range having any two of these values as endpoints, inclusive of the endpoints. In some embodiments, the glass composition may include 0.01 mol % to 0.2 mol % SnO₂. In some embodiments, the glass composition may include 0.04 mol % to 0.17 mol % SnO₂.

In some embodiments, the glass composition for glass layers discussed herein may be a composition including a value for R₂O (alkali metal oxide(s))+RO (alkali earth metal oxide(s)) in the range of 10 mol % to 30 mol %. In some embodiments, R₂O+RO may be 10 mol %, 15 mol %, 20 mol %, 25 mol %, or 30 mol %, or a mol % within any range having any two of these values as endpoints, inclusive of the endpoints. In some embodiments, R₂O+RO may be in the range of 15 mol % to 25 mol %. In some embodiments, R₂O+RO may be in the range of 16.01 mol % to 20.61 mol %.

A substrate or layer may be strengthened to form a strengthened substrate or layer. As used herein, the terms “strengthened substrate” or “strengthened layer” may refer to a substrate/layer that has been chemically strengthened, for example through ion exchange of larger ions for smaller ions in the surface of the substrate/layer. Other strengthening methods known in the art, for example thermal tempering, or utilizing a mismatch of the coefficient of thermal expansion between portions of the substrate/layer to create compressive stress and central tension regions, may also be utilized to form strengthened substrates/layers.

Where the substrate/layer is chemically strengthened by an ion exchange process, the ions in the surface layer of the substrate/layer are replaced by—or exchanged with—larger ions having the same valence or oxidation state. Ion exchange processes are typically carried out by immersing a substrate/layer in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate/layer in a salt bath (or baths), use of multiple salt baths, additional steps, for example annealing, washing, and the like, are generally determined by the composition of the substrate/layer and the desired compressive stress (CS), depth of compressive stress layer (or depth of layer) of the substrate that result from the strengthening operation. By way of example, ion exchange of alkali metal-containing glass substrates/layers may be achieved by immersion in at least one molten bath containing a salt for example, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates/layers are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath is diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

### Example

### Preparation of Hard-Coating Composition

The coating composition was prepared by mixing Ebecryl™ 8602 (45 parts per weight, commercially available from Allnex), Photomer® 4356 (20 parts per weight, commercially available from IGM Resins), Sartomer SR399 (20 parts per weight, commercially available from Arkema Inc.), Ebecryl™ LED 02 (10 parts per weight, commercially available from Allnex), and Esacure KTO 46 (5 parts per weight, commercially available from IGM Resins) in propylene glycol methyl ether acetate (166.67 parts per weight, Sigma-Aldrich). The resulting mixture was filtered (pore size 0.2 μm, Whatman™), and then OPTOOL DAC-HP (1 part per weight, commercially available from Daikin Industries, Ltd.) and NANOBYK-3601 (1 part per weight, commercially available from BYK USA Inc.) were added, followed by filtration (pore size 1.0 μm, Whatman™). The final concentration range of the coating composition was adjusted to 20 to 60 wt. % solids through further dilution with either propylene glycol methyl ether acetate (Sigma-Aldrich), methyl isobutyl ketone (Sigma-Aldrich), or 2-pentanone (Sigma-Aldrich).

Preparation of Glass Article with Hard-Coat Layer on Glass Layer

Prior to coating, all glass samples are pretreated with (3-ACRYLOXYPROPYL)TRIMETHOXYSILANE as an adhesion promoter. To pretreat the glass, the glass is soaked in 2% (w/w) of (3-Acyloxypropyl) trimethoxysilane in acidified (pH˜5) 95:5 ethanol:H2O solution for 2 min and then rinse with ethanol for 2 min. After taking out of ethanol rinsing solution and drying, the samples is baked at 120° C. for 1 min and ready for further coating process.

The coating composition prepared as above was coated on ion-exchanged alkali-aluminosilicate thin sheet glass articles, as prepared with pretreatment described above, in an nRad slot die coater (nTact) using a shim thickness of 2 mil at a coating speed of ˜30 mm/s and a coating flow rate of 30-200 μL/s. Subsequently the coating, solvents were removed at 90° C. for 10 min, followed by curing a dried film in a Fusion F300S UV curing system (Heraeus Noblelight America LLC) equipped with a D bulb lamp and at the UV dosage of 5000 mJ/cm². Samples of glass articles with a 50 μm thick glass layer and a top optically transparent polymeric hard-coat layer having a thickness of 20 μm, 30 μm, 40 μm and 50 μm were prepared for testing their mechanical and optical properties, the results of which are summarized in Tables 1 and 4. Samples of glass articles with a 30 μm thick glass layer and a top optically transparent polymeric hard-coat layer having a thickness of 10 μm, 20 μm, and 30 μm were prepared for testing their mechanical properties, the results of which are summarized in Table 2. Samples of glass articles with a 75 μm thick glass layer and a top optically transparent polymeric hard-coat layer having a thickness of 15 μm, 30 μm, and 40 μm were prepared for testing their mechanical properties, the results of which are summarized in Table 3.

### Mechanical Properties of Glass Articles

The glass articles prepared as above were tested for mechanical properties. Samples of glass articles tested included: a 50 μm thick glass layer with no optically transparent polymeric hard-coat layers (control), and a top optically transparent polymeric hard-coat layer having a thickness of 20 μm, 30 μm, 40 μm or 50 μm disposed on a top surface of a 50 μm thick glass layer.

### 1. Static Bend Test

Two-point in-fold and out-fold static bend tests were conducted based on those described previously without PET layer as a back substrate. The samples of the glass articles prepared as above were bent at 60° C. and 93% relative humidity for 240 hours. The plate distances for the glass articles avoiding failure are shown in Table 1.

### 2. Dynamic Bending Test

Two-point in-fold and out-fold dynamic bend tests were conducted based on those described previously without PET layer as a back substrate. The samples of the glass articles prepared as above were bent at about 22° C. and 50% relative humidity for 200,000 cycles. The plate distances for the glass articles avoiding failure are shown in Table 1.

### 3. Glass Fragment Ejection Test

After the two-point in-fold static bend test as described above, the glass articles were continuously bent until broke. Then the broken glass were imaged at 20× Keyence VHX-6000 microscope. All the glass article samples had zero glass fragment ejection except for the control sample.

### 4. Pen Drop Test

Pen drop tests were conducted based on those described previously. The glass articles prepared as above were adhered to a 100 μm PET using a 50 μm optically transparent adhesive layer (3M™ Optically Clear Adhesives 8212). The pen for testing has a tungsten carbide ball point tip of 0.7 mmm diameter and a weight of 5.8 grams. Table 1 lists the average pen drop height on the glass articles.

### 5. Pencil Hardness Test

Pencil hardness of the glass articles was measured using a Gardco HA-3363 pencil hardness tester according to Japanese Standard JIS K 5600-5-4 with a test load of 750 grams. The test results are shown in Table 1.

### 6. Taber Abrasion Test

Scratch resistance of the glass articles prepared as above was measured by Taber Abrasion test. The Taber Abrasion test was performed with Taber Linear Abrader (Taber Industries, North Tonawanda, NY) with 750 g of steel wool pad No. 0000 at 45 cycles/min. Samples of the glass articles were cleaned with ethanol prior to testing. After 2500 cycles, very faint scratches were observed under microcopy on the tested samples.

### 7. Water Contact Angle Test (WCA)

Water contact angle was measured before and after abrasion on a Taber Abrasion tester. If the water contact angle does not drop by more than 10 degrees after 10000 cycles, then the sample passes the test. If the water contact angle drops by more than 10 degrees after 10000 cycles, then the sample fails. The apration is carried out as follows. The test is carried out on a Taber Abrasion 5900 tester, with a 1 kg load, 40 cycles/min, 40 mm stroke distance. One back and force motion is considered as one cycle. Bon Star #0000 steel wool was used to scratch against the glass surface (precoated with the hard coat). The steel wool was cut to slight bigger size than the head (2 cm×2 cm²), and placed directly under it. The fiber orientation is along the motion direction. Before testing the sample, the steel wool was preconditioned by moving it across a PET sheet with the same conditions as above for 100 cycles. The glass side of the samples were taped down onto a smooth glass plate and placed on the stage with the hard-coated surface facing upwards to engage the steel wool.

Table 1 shows the mechanical test results for various test samples. As shown in the Table 1, the control sample exhibited an average pen drop height of 3.6. When the top surface of the glass layer was coated, the average pen drop height was dramatically increased. The results show that disposing an optically transparent hard-coat layer directly on the top surface of a glass layer as described herein can significantly improve the glass layer's pen drop performance, and thus the glass layer's puncture and impact resistance. In addition, all the glass article samples showed zero glass fragment ejection after in-fold bending except for the control sample.

TABLE 1
Mechanical Properties of 50 μm Glass Articles

| | Control | | 20 μm HC | | 30 μm HC | 40 μm HC | 50 μm HC |
|---|---|---|---|---|---|---|---|
| Warp aft. | 1 | mm | <1 | mm | 3 mm (infold) | 5 mm (infold) | — |
| 8 mm | | | | | 2 mm (outfold) | 8 mm (outfold) | |
| Dyn. Bnd | | | | | | | |
| Warp aft. | <2 | mm | 12 mm (infold) | | 21.4 mm (infold) | 26.4 mm (infold) | — |
| 8 mm | | | 6 mm (outfold) | | 7.6 mm (outfold) | 1.5 mm (outfold) | |
| Stat. Bnd | | | | | | | |
| Pen | 3.6 | cm | 7.6 | cm | 8.9 cm | 12 cm | 10 cm |
| Drop | | | | | | | |
| Pencil | 9H | | 6H | | 6H | 8H | — |
| Hardness | | | | | | | |
| WCA | | | | | Pass | | |

TABLE 2
Mechanical Properties of 30 um Glass Article

| | Control | 10 μm HC | 20 μm HC | 30 μm HC |
|---|---|---|---|---|
| Dynamic Bend | | 1.5 mm (infold) | | |
| Static Bend | | 1.5 mm (infold) | | |
| Pen drop | 3 cm | 9 cm | 11 cm | 11 cm |
| Pencil Hardness | | 8H | | |
| | | both with and | | |
| | | without PET | | |
| | | layer as a back | | |
| | | substrate | | |
| WCA | | Pass | | |

TABLE 3
Mechanical Properties of 75 um Glass Article

| | Control | 15 μm HC | 30 μm HC | 40 μm HC |
|---|---|---|---|---|
| Pen drop | 6 cm | 8 cm | 12 cm | 12 cm |
| WCA | | | Pass | |

### Optical Properties of Glass Articles

Optical properties of the glass articles prepared as above (transmittance and b*) were measured with a BYK Haze Gard Plus instrument (commercially available from BYK-Gardner GmbH, Germany). Transmittance measures the amount of light that passes through a material and is a percent comparing the light energy transmitted through the material to the light energy that enters into the material. Transmittance was measured in a wavelength range from 380 nm to 780 nm. b* value (which correlates to the perceived degree of yellowing) was calculated based on % Transmittance between 380 to 780 nm, with 10 degree viewing angle and D65 daylight illuminant. b* values were obtained before and after environmental aging. The environmental aging of the glass article was conducted under xenon arc bulb (0.9 W/m²/nm at 340 nm) for 96 hours at 55° C. and 30% relative humidity. The optical properties of the glass articles are listed in Table 2.

TABLE 4
Optical Properties of 50 um Glass Articles

| Test | Control | 20 μm HC | 30 μm HC | 40 μm HC | 50 μm HC |
|---|---|---|---|---|---|
| Transmittance | >91% | 88.9-91.7% | 88.3-91.7% | 87.8-91.6% | 86.7-91.5% |
| b*, before aging | 0.47 | 0.54 | 0.71 | 0.76 | 0.07 |
| b*, after aging | 0.70 | 1.02 | 1.27 | 1.60 | 0.09 |

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

1. A glass article, comprising:
a glass layer having a thickness in a range of 10 microns to 200 microns; and
a top optically transparent polymeric hard-coat layer disposed on a top surface of the glass layer, having a thickness in a range of 0.1 microns to 200 microns and a pencil hardness of 6H or more,
wherein the top optically transparent polymeric hard-coat layer is derived from an actinic radiation curable acrylic composition and the glass article avoids ejection of glass shard particles from the glass article upon bending to a failure during a static two-point bend test.

2. The glass article of claim 1, wherein the actinic radiation curable acrylic composition comprises (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt. %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more radical initiators; and (e) one or more organic solvents, wherein the total amount of monomer and functional oligomer solids amounts to 100%.

3. The glass article of claim 2, wherein the actinic radiation curable acrylic composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

4. The glass article of claim 3, wherein the actinic radiation curable acrylic composition further comprises from 2 to 30 wt. %, based on the total weight of (a), (b), (c), and (d), of one or more sulfur-containing polyol (meth)acrylates.

5. The glass article of claim 2, wherein the actinic radiation curable acrylic composition further comprises 20 wt. % or less, based on the total monomer solids, of one or more mono- and di-functional (meth)acrylates, wherein the total amount of monomer and functional oligomer solids amounts to 100%.

6. The glass article of claim 2, wherein the amount of the (e) ranges from 10 to 80 wt. %, based on the total weight of the actinic radiation curable acrylic composition.

7. The glass article of claim 1, wherein the pen drop height is 2 times, preferably 2.5 times, or more than that of the control pen drop height of the glass layer without the top optically transparent polymeric hard-coat layer.

8. The glass article of claim 1, wherein the top optically transparent polymer hard-coat layer has a thickness in a range of 0.1 microns to 100 microns, and wherein the glass layer has a thickness in a range of 10 microns to 100 microns.

9. The glass article of claim 1, wherein at least one of:
the glass article avoids the failure during the static two-point bend test when held between two plates at the plate distance of 10 millimeters for 240 hours at 60° C. and 93% relative humidity; or
the glass article avoids the failure during the dynamic two-point bend test when the glass article is cyclically bent 200,000 times between two plates to the plate distance of 10 millimeters at 23° C. and 50% relative humidity.

10. The glass article of claim 1, wherein the optically transparent polymeric hard-coat layer has a percent elongation in a range of 1% to 10%, and wherein the optically transparent polymeric hard-coat layer has a modulus of elasticity in a range of 1 GPa to 15 GPa.

11. The glass article of claim 1, further comprising an adhesion promoter between the top surface of the glass layer and the top optically transparent polymeric hard-coat layer.

12. The glass article of claim 1, further comprising a coating layer disposed on a top surface of the top optically transparent polymeric hard-coat layer, wherein the coating layer is selected from the group consisting of an anti-reflection coating layer, an anti-glare coating layer, an anti-fingerprint coating layer, an anti-microbial coating layer, and an easy-to-clean coating layer.

13. The glass article of claim 1, wherein the glass article is devoid of a layer disposed over the top optically transparent polymeric hard-coat layer having a pencil hardness greater than that of the top optically transparent polymeric hard-coat-layer.

14. An article comprising:
a cover substrate comprising the glass article of claim 1, wherein the article is a consumer electronic product comprising:
a housing comprising a front surface, a back surface, and side surfaces;
electrical components disposed at least partially within the housing, the electrical components comprising a controller, a memory, and a display, the display at or adjacent the front surface of the housing; and
the cover substrate disposed over the display or forms at least a portion of the housing.

15. A method of making a glass article, the method comprising:
(a) coating an optically transparent polymeric hard-coat composition on a top surface of a glass layer having a thickness in a range of 10 microns to 200 microns; and
(b) polymerizing and curing the optically transparent polymeric hard-coat composition on the top surface of the glass layer to form an optically transparent polymeric hard-coat layer having a thickness in a range of 0.1 microns to 200 microns,
wherein the optically transparent polymeric hard-coat composition comprises (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt. %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more radical initiators; and (e) one or more organic solvents for the monomer composition, wherein the total amount of monomer and functional oligomer solids amounts to 100%.

16. The method of claim 15, wherein the optically transparent polymeric hard-coat composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

17. The method of claim 16, wherein the optically transparent polymeric hard-coat composition further comprises from 2 to 30 wt. %, based on the total weight of (a), (b), (c), and (d), of one or more sulfur-containing polyol (meth)acrylates.

18. A method of making a glass article, the method comprising:
(a) providing an optically transparent polymeric hard-coat layer having a thickness in a range of 0.1 microns to 200 microns; and
(b) laminating the optically transparent polymeric hard-coat layer on a top surface of a glass layer having a thickness in a range of 10 to 200 microns,
wherein the optically transparent polymeric hard-coat layer is made from polymerizing and curing an acrylic composition comprising (a) one or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer; (b) from 3 to 30 wt. %, based on the total weight of monomer solids, of one or more (meth)acrylate monomer containing an isocyanurate group; (c) from 5 to 60 wt. %, based on the total weight of monomer solids, of one or more aliphatic urethane (meth)acrylate functional oligomer having from 6 to 12 (meth)acrylate groups; (d) from 2 to 10 wt. %, based on total monomer solids, of one or more radical initiators; and (e) one or more organic solvents for the monomer composition, wherein the total amount of monomer and functional oligomer solids amounts to 100%.

19. The method of claim 18, wherein the optically transparent polymeric hard-coat composition comprises from 9 to 70 wt. % in total, based on the total monomer solids, of (a) two or more multifunctional (meth)acrylate diluents selected from the group consisting of an aliphatic trifunctional (meth)acrylate monomer, an aliphatic tetrafunctional (meth)acrylate monomer, and an aliphatic pentafunctional (meth)acrylate monomer, wherein the total amount of monomer and functional oligomer solids amounts to 100%.

20. The method of claim 18, wherein the optically transparent polymeric hard-coat composition further comprises from 2 to 30 wt. %, based on the total weight of (a), (b), (c), and (d), of one or more sulfur-containing polyol (meth)acrylates.
